(19) United States
(12) Patent Application Publication
(10) Pub. No.: US 2009/0106073 A1
(43) Pub. Date: Apr. 23, 2009

(54) BUSINESS TO MEDIA RESERVATION BUSINESS PROCESS

(75) Inventors: Jacek Waksmundzki, Warsaw (PL); Pawel Demczuk, Warsaw (PL); Lukasz Michalski, Warsaw (PL)

Correspondence Address: MARSH, FISCHMANN & BREYFOGLE LLP, 8055 East Tufts Avenue, Suite 450, Denver, CO, 80237, US

(73) Assignee: Jacek Waksmundzki, Warsaw (PL)

(21) Appl. No.: 12/255,484

(22) Filed: Oct. 21, 2008

Related U.S. Application Data
(60) Provisional application No. 60/981,744, filed on Oct. 22, 2007.

(51) Int. Cl. G06Q 10/00

(52) U.S. Cl. 705/8

(57) ABSTRACT

A process of developing a computer network based universal reservation system. In one embodiment, such a process includes the steps of obtaining a service interface broker, providing a service offering system that a service developer wants included in the computer network based universal reservation system with functionality of the service offering system being extended by functionality provided by the service interface broker, obtaining a marketplace interface broker, and providing a marketplace system that a marketplace supplier wants included in the computer network based universal reservation system with functionality of the marketplace system being extended by functionality provided by the marketplace interface broker.

### RELATED APPLICATION INFORMATION

This application claims priority from U.S. Provisional Patent Application Ser. No. 60/981,744 entitled “BUSINESS TO MEDIA RESERVATION BUSINESS PROCESS” filed on Oct. 22, 2007, which is incorporated by reference herein in its entirety.

### FIELD OF THE INVENTION

The present invention relates generally to facilitating the reservation of services offered by service providers, and more particularly to a developing computer network connected systems for the reservation of services in any business domain using multiple analog and digital media.

### BACKGROUND OF THE INVENTION

The Internet and other computer networks have proven to be a useful medium for connecting service providers with persons seeking to obtain services. For example, a patient might utilize the Internet to access their doctor's office Web site to schedule an appointment, a driver might access a car rental agency's Web site via the Internet to reserve a rental car, or a diner might utilize the Internet to access a restaurant's Web site to obtain a dinner reservation. In each of the foregoing examples, the scheduling function is integrated with the system that presents information about the available service. Furthermore, access to the system that presents information about the available services may be limited to particular marketplaces. For example, the doctor's office, car rental agency's, or restaurant's Web site might be accessible via a Web portal, but not via a mobile phone portal or a digital television system. Additionally, the clients seeking services may be presented with a myriad of different scheduling systems and processes in order to reserve a variety of differing services since the clients directly interface with the service offering systems.

### SUMMARY OF THE INVENTION

Accordingly, the present invention provides a process for developing a computer network based universal reservation system (CNBURS) capable of performing every type reservation relating to services between customers and service providers in real time, simultaneously over every analog and digital media, in multiple digital marketplaces through a single scheduling agent. A “service” may, for example, be considered an arrangement among a service provider and one or more customers by which the customer(s) receives/receive the use of one or more resources from the service provider. Use of the resource(s) may be received by the customer(s) for a scheduled period of time (e.g., for an hour, a day, a week, or the duration of a performance such as a movie, a play, or a sporting event), although it is also possible for the duration of the service to be open-ended. A “resource” may, for example, include a good that is exchanged between the service provider and the customer(s) as well as an activity that is performed for or on behalf of the customer(s). The activity may be performed by one or more individuals, one or more entities, one or more devices, or a combination of individuals, entities and/or devices. In general, a “customer” is any individual or entity that may receive a service from a service provider. The terms “customer” and “client” may be used interchangeably herein. Further, a “reservation” refers to any activity involving scheduling the delivery of a service. A “service provider” may be any individual or entity that possesses resources and is capable of providing the use of those resources to customers. Where the service provider owns a resource, ownership of the resource may be maintained by the service provider during the service.

One aspect of the process of the present invention is to establish the roles, responsibilities and interactions between various actors and components derived from the B2M reservation standard and the universal B2M reservation system. In general, the B2M reservation standard specifies a standard that provides for the visualization of, and the renting/scheduling of services, simultaneously, in real time, and over multiple analog and digital media in multiple analog and digital marketplaces. The B2M reservation standard is more specifically described in a separate U.S. patent application filed contemporaneously herewith entitled “BUSINESS TO MEDIA RESERVATION STANDARD” (which application claims priority from U.S. Provisional Application Ser. No. 60/981,752 filed Oct. 22, 2007), the entire disclosure of which is incorporated by reference herein. In general the universal B2M reservation system provides a system that provides easy brokering of reservations relating to services between customers and service providers. The universal B2M reservation system is more specifically described in a separate U.S. patent application filed contemporaneously herewith entitled “UNIVERSAL BUSINESS TO MEDIA RESERVATION SYSTEM” (which application claims priority from U.S. Provisional Application Ser. No. 60/981,760 filed Oct. 22, 2007), the entire disclosure of which is incorporated by reference herein. In accordance with this aspect, this covers the following:

a. Universal B2M reservation system's development process;

b. Universal B2M reservation system's modules ownership; and

c. Universal B2M reservation system's open structure which enables the following:
i. the ability to offer reservation services to different kinds of domains (e.g. auto parts, medical reservations and ski rental),
ii. the ability to use different technologies and programming languages (e.g. Windows, Unix and OS X/PHP and Java),
iii. the ability to use different languages (e.g. English, German, French and Polish),
iv. the ability to implement variety of business logic approaches (e.g. service bundles and linked services),
v. the ability to offer access to the system via every analog and digital media (e.g. newspaper, billboard, Internet and cell phone), over multiple marketplaces (e.g. domain specific, geographic, bundled and universal).

In one embodiment, the process of the present invention may be presented as a process combining cooperation and interaction of three groups of actors and six components. The three actors are: one or more marketplace suppliers, a universal reservation system operator (URSO), and one or more service developers. The components owned by the universal reservation system operator may include: a marketplace interface broker (MIB), a service interface broker (SIB), and a scheduling agent. Components that are part of the process but are external to the universal reservation system operator may belong to the marketplace suppliers and service developers. Such components include, respectively, marketplaces belonging to marketplace suppliers and service offering systems (SOSs) belonging to service developers. Both groups may also own media interfaces.

The universal reservation system operator may develop the scheduling agent, the marketplace interface broker and the service interface broker. Marketplace suppliers receive the marketplace interface broker and develop marketplaces (the client's interfaces to CNBURS). Service developers receive the service interface broker and develop service offering systems (service provider interfaces to CNBURS).

The process of developing CNBURS allows:
developing a reservation system with marketplaces and service offering systems separated from the scheduling agent.
creating a reservation system with particular components belonging to different owners, and
creating a reservation system with multiple marketplaces and service offering systems.

By using MIB and SIB in accordance with the presented process, the reservation system becomes truly universal and can offer reservation services to different kinds of reservation domains (e.g. computer purchase reservation, medical services and ski rental, etc.). This is possible due to the fact that CNBURS is not developed by only one or several developers but it can have as many domain-specific marketplace suppliers and service developers as the scheduling agent is able to serve.

With the MIB and SIB being operating system and programming language agnostic and following the presented process of using them, CNBURS can be made available for all leading technologies and programming languages.

In one embodiment, the process of the present invention states that client's and service provider's interfaces within the CNBURS are developed independently from the URSO by different entities. This implicates that language used within graphical user interfaces (GUIs) developed by marketplace suppliers and service developers depends only on the perceived market needs which allow the system conditions to become multi language with a potentially unlimited number of supported languages.

The process of the present invention also allows for the possibility of developing CNBURS with an unlimited number of service offering systems developed by different entities (service developers).

The process of the present invention further allows for the possibility of developing CNBURS with an unlimited number of marketplaces developed by different entities (marketplace suppliers).

The process of the present invention also gives marketplace suppliers freedom in the marketplace development process. Marketplace suppliers can choose what kind and what number of business domains available at the scheduling agent they want to offer on their marketplaces and how interaction with the client should look like. As this invention lets an unlimited number of marketplace suppliers cooperate with CNBURS, the number of marketplaces with different business logics is also potentially unlimited.

The present invention includes various additional aspects and features. In one more aspect a process of developing a computer network based universal reservation system includes the steps of obtaining a service interface broker, providing a service offering system, obtaining a marketplace interface broker, and providing a marketplace system. The service offering system may be one that a service developer wants included in the computer network based universal reservation system, with functionality of the service offering system being extended by functionality provided by the service interface broker. The marketplace system may be one that a marketplace supplier wants included in the computer network based universal reservation system, with functionality of the marketplace system being extended by functionality provided by the marketplace interface broker.

In yet one more aspect, a process of developing a computer network based universal reservation system that enables reservations by one or more customers of services offered by one or more service providers, wherein a service offered by the one or more service providers comprises an arrangement wherein a customer receives the use of a resource from a service provider, includes the steps of providing a scheduling agent system, providing a service interface broker to a service developer, and providing a marketplace interface broker to a marketplace supplier. In providing a service interface broker to a service developer, the service interface broker may be usable by the service developer to develop a service offering system including functionality provided by the service interface broker when there is not an existing service offering system that the service developer wants included in the computer network based universal reservation system and to add functionality provided by the service interface broker to an existing service offering system when there is an existing service offering system that a service developer wants included in the computer network based universal reservation system, with functionality of the service offering system being extended by functionality provided by the service interface broker. In providing a marketplace interface broker to a marketplace supplier, the marketplace interface broker may be usable by the marketplace supplier to develop a marketplace system including functionality provided by the marketplace interface broker when there is not an existing marketplace system that the marketplace supplier wants included in the computer network based universal reservation system and to add functionality provided by the marketplace interface broker to an existing marketplace system when there is an existing marketplace system that a marketplace supplier wants included in the computer network based universal reservation system, with functionality of the marketplace system being extended by functionality provided by the marketplace interface broker. The process may also include the step of including in the computer network based universal reservation system at least one of the scheduling agent system, the service offering system with the functionality provided by the service interface broker, and the marketplace system with the functionality provided by the marketplace interface broker.

Various refinements exist of the features noted in relation to the various aspects of the present invention. Further features may also be incorporated in the various aspects of the present invention. These refinements and additional features may exist individually or in any combination, and various features of the various aspects may be combined. These and other aspects and advantages of the present invention will be apparent upon review of the following Detailed Description when taken in conjunction with the accompanying figures.

### DESCRIPTION OF THE DRAWINGS

For a more complete understanding of the present invention and further advantages thereof, reference is now made to the following Detailed Description, taken in conjunction with the drawings, in which:

FIG. 1 is a block diagram showing one embodiment of a computer network based universal reservation system presenting involved actors and components; and

FIG. 2 shows one embodiment of a computer network based universal reservation system development process.

### DETAILED DESCRIPTION

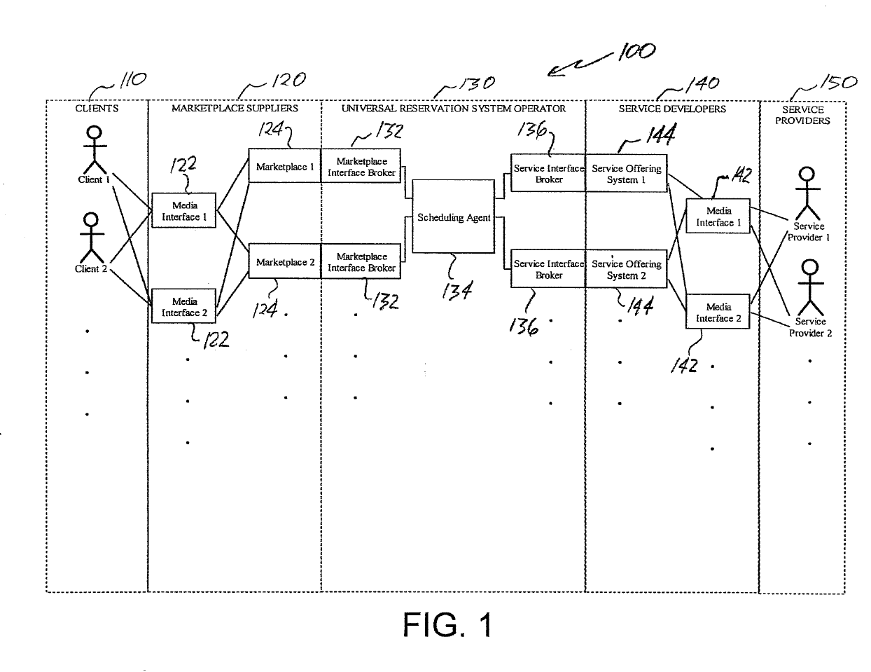

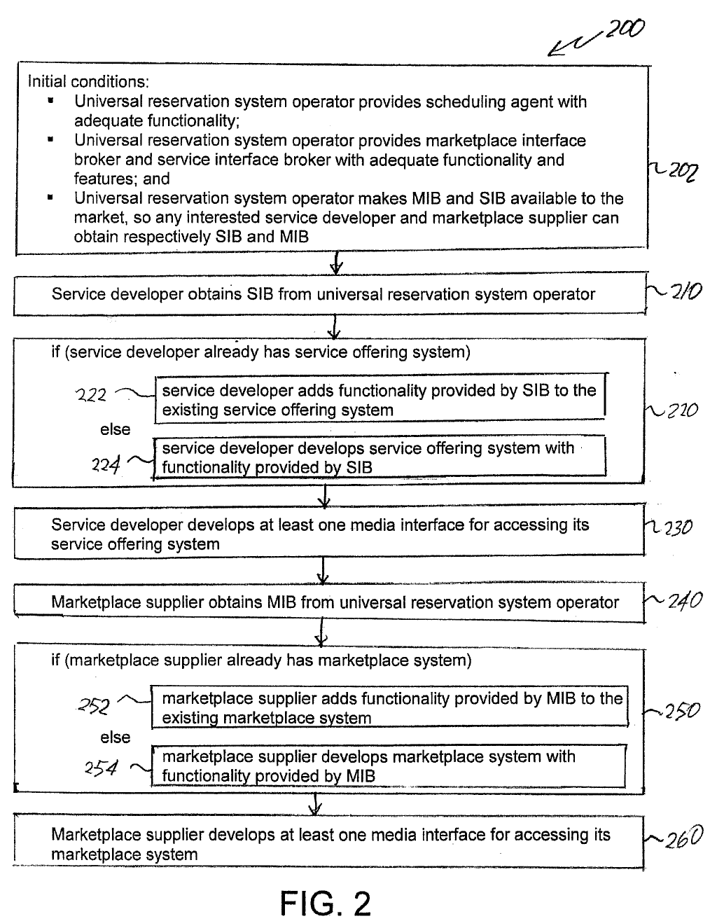

FIG. 1 depicts one embodiment of a CNBURS 100 that may be developed using the CNBURS development process 200, one embodiment of which is presented in FIG. 2. The CNBURS development process 200 combines interactions of three (3) groups of actors and six (6) component types (see FIG. 1). Component types used in this process include:
A media interface 122, 142 is a set of all tools (e.g. php-html scripts, OpenTV applications, etc.) needed to support client 110 to marketplace 124, marketplace 124 to client 110, service provider 150 to service offering system 144, and service offering system 144 to service provider 150 directed communication through digital media (e.g. mobile phone with an Internet browser, PC with an Internet browser, etc.). The media interface 122 is also a set of tools (e.g. graphics, texts, etc.) needed to enable marketplace 124 to client 110 directed communication through analog media (e.g. billboards, newspapers, etc.).
A marketplace 124 is a computer network enabled computer system where services are available through media interfaces 122 to the clients 110. In this regard, marketplaces 124 may also be referred to herein as marketplace systems 124.
A marketplace interface broker (MIB) 132 is a tool integrating marketplaces 124 with a scheduling agent 134. The MIB 132 provides functionality enabling different kinds of marketplaces 124 to be connected to the scheduling agent 134.
A scheduling agent 134 is a computer network enabled computer system capable of processing reservations of services on behalf of a service provider 150 and handling reservations between marketplace interface brokers 132 and service interface brokers 136. In this regard, the scheduling agent 134 may also be referred to herein as the scheduling agent system 134. The scheduling agent 134 is connected via a computer network (not shown) to one or more service offering systems 144 using service interface brokers 136 and to marketplaces 124 using marketplace interface brokers 132.
A service interface broker (SIB) 136 is a tool integrating service offering systems 144 with the scheduling agent 134. The SIB 136 provides functionality enabling different kinds of service offering systems 144 to be connected to the scheduling agent 134.
A service offering system 144 is a computer network enabled computer system where services are defined and managed by service providers 150 through media interfaces 142.
   The actors cooperating in the process of developing CNBURS include:
A universal reservation system operator 130 that is the provider of three components: the scheduling agent 134, the marketplace interface broker 132 and the service interface broker 136.
A marketplace supplier 120 that is the developer of one or more marketplaces 124 and one or more media interfaces 122.
A service developer 140 that is the developer of one or more service offering systems 144 and one or more media interfaces 142.

CNBURS development may proceed in accordance with a process 200 such as depicted in FIG. 2. When the CNBURS development process begins, there are several initial conditions 202 including: (1) the universal reservation system operator 130 provides the scheduling agent 134 with adequate functionality; (2) the universal reservation system operator 130 provides the MIB 132 and the SIB 136 with the adequate functionality and features; and (3) the universal reservation system operator 130 makes the MIB 132 and the SIB 136 available to the market, so any interested service developer 140 and marketplace supplier 120 can obtain, respectively, the SIB 136 and the MIB 132.

With the initial conditions 202 satisfied, one embodiment of the CNBURS development process 200 proceeds in the following manner. In a first step 210, the service developer 140 obtains the SIB 136 from the universal reservation system operator 130. In a second step 220 the service developer undertakes one of two sub-steps. If the service developer 140 already has a service offering system 144, the service developer 140 undertakes sub-step 222 wherein the service developer 140 adds functionality provided by the SIB 136 to the existing service offering system 144; else, the service developer 140 undertakes sub-step 224 wherein the service developer 140 develops a service offering system 144 with functionality provided by the SIB 136. In a third step 230, the service developer 140 develops at least one media interface 142 for accessing its service offering system 144.

In a fourth step 240, the marketplace supplier 120 obtains the MIB 132 from the universal reservation system operator 130. In a fifth step 250, the marketplace supplier 120 undertakes one of two sub-steps. If the marketplace supplier 120 already has a marketplace system 124, the marketplace supplier 120 undertakes sub-step 252 wherein the marketplace supplier 120 adds functionality provided by the MIB 132 to the existing marketplace system 124; else, the marketplace supplier 120 undertakes sub-step 254 wherein the marketplace supplier 120 develops the marketplace system 124 with functionality provided by the MIB 132. In a sixth step 260, the marketplace supplier 120 develops at least one media interface 122 for accessing its marketplace system 120.

In other embodiments of the CNBURS development process, the order of one or more of the aforementioned steps (210-260) may be arranged in a different manner. For example, steps undertaken by the service developer 140 (e.g., steps 210-230) may proceed in parallel with the steps undertaken by the marketplace supplier 120 (e.g., steps 240-260) or after the steps undertaken by the marketplace supplier 120. Regardless of the order in which the steps are arranged, the CNBURS 100 starts to work at its full functionality when at least one service developer 140 and at least one marketplace supplier 120 fulfill their respective activities of the CNBURS development process 200.

### Ownership of CNBURS

Actors (e.g., the universal reservation system operator 130, marketplace suppliers 120 and service developers 140) participating in development of CNBURS 100 partially own the system 100 by owning its specified elements. Three groups of actors and their components are listed below:
The universal reservation system operator 130 owns the scheduling agent system 134, the service interface broker 136 and the marketplace interface broker 132,
Each service developer 140 owns at least one service offering system 144 and at least one media interface 142, and
Each marketplace supplier 120 owns at least one marketplace system 124 and at least one media interface 122.
   While there is only one universal reservation system operator 130, the number of service developers 140 and marketplace suppliers 120 participating in developing a CNBURS 100 is not limited.

### Roles and Responsibilities

The role of the universal reservation system operator 130 in the CNBURS development process 200 includes:
supplying marketplace suppliers 120 and service developers 140, respectively, with MIBs 132 and SIBs 136;
assuring error-free and secure communication between provided MIBs 132 and SIBs 136;
providing the scheduling agent 134 which will operate efficiently and reliably; and
providing the functionality that satisfies marketplace suppliers 120 and service developers 140 needs according to the CNBURS 100.

The role of marketplace suppliers 120 includes:
building marketplaces 124 in any area of perceived market need (e.g. auto parts reservation, hair-dressers, ski rentals, hotels, etc.);
establishing the tailored user interfaces for marketplaces 124;
linking or excluding service domains in order to improve the client experience on a given marketplace 124; and
providing access to marketplaces 124 to the clients 110 through required analog and digital media by media interfaces 122 (e.g. newspapers, billboards, cell phones, WWW sites, digital TV applications, etc.).

The role of service developers 140 includes:
building service offering systems 144 in any perceived need business domain (e.g. computer purchase reservation, auto parts, hair-dressers, ski rentals, hotels, etc.);
establishing the tailored user interfaces for service offering systems 144;
developing service provider's 150 reservation delegations within service offering systems 144;
developing functionality of assigning service provider's 150 offer to a unique universal service code;
linking to service offering systems 144 any other domain-specific tools (e.g. patient medical records, restaurant table configuration, etc.); and
providing access to service offering systems 144 to the service providers 150 through required digital media by media interfaces 142 (e.g. cell phone applications, WWW applications, digital TV applications, computer network enabled local applications, etc.).

While various embodiments of the present invention have been described in detail, further modifications and adaptations of the invention may occur to those skilled in the art. However, it is to be expressly understood that such modifications and adaptations are within the spirit and scope of the present invention.

What is claimed is:

1. A process of developing a computer network based universal reservation system, said process comprising the steps of:
obtaining a service interface broker;
providing a service offering system that a service developer wants included in the computer network based universal reservation system, wherein functionality of the service offering system is extended by functionality provided by the service interface broker;
obtaining a marketplace interface broker; and
providing a marketplace system that a marketplace supplier wants included in the computer network based universal reservation system, wherein functionality of the marketplace system is extended by functionality provided by the marketplace interface broker.

2. The process of claim 1 wherein the service interface broker is obtained from a universal reservation system operator by the service developer.

3. The process of claim 1 wherein the marketplace interface broker is obtained from a universal reservation system operator by the marketplace supplier.

4. The process of claim 1 further comprising the step of:
developing at least one media interface for accessing the service offering system.

5. The process of claim 4 wherein the at least one media interface is developed by the service developer.

6. The process of claim 4 wherein the at least one media interface enables two-way communication between the service offering system and a service provider, wherein the at least one media interface enables operation of the service offering system by the service provider to define offers of services available for reservation.

7. The process of claim 1 further comprising the step of:
developing at least one media interface for accessing the marketplace system.

8. The process of claim 7 wherein the at least one media interface is developed by the marketplace supplier.

9. The process of claim 7 wherein the at least one media interface provides at least one-way communication from the marketplace system to customers, wherein offers of services available for reservation defined by a service provider are communicated from the marketplace system to the customers via the at least one media interface.

10. The process of claim 9 wherein the at least one media interface provides two-way communication between the marketplace system and the customers, wherein reservation requests by the customers are communicated from the customers to the marketplace system via the same at least one media interface.

11. The process of claim 9 wherein at least one additional media interface provides at least return channel communication from the customers to the marketplace systems, and wherein reservation requests by the customers are communicated from the customers to the marketplace system via the at least one additional media interface.

12. The process of claim 1 further comprising:
providing a scheduling agent system.

13. The process of claim 12 further comprising:
including in the computer network based universal reservation system at least one of the scheduling agent system, the service offering system with the functionality provided by the service interface broker, and the marketplace system with the functionality provided by the marketplace interface broker.

14. The process of claim 12 wherein the scheduling agent system is provided by a universal reservation system operator.

15. The process of claim 1 wherein said step of providing a service offering system comprises:
developing a service offering system including functionality provided by the service interface broker when there is not an existing service offering system that the service developer wants included in the computer network based universal reservation system.

16. The process of claim 15 wherein said step of developing a service offering system including functionality provided by the service interface broker is performed by the service developer.

17. The process of claim 1 wherein said step of providing a marketplace system comprises:
developing a marketplace system including functionality provided by the marketplace interface broker when there is not an existing marketplace system that the marketplace supplier wants included in the computer network based universal reservation system.

18. The process of claim 17 wherein said step of developing a marketplace system including functionality provided by the marketplace interface broker is performed by the marketplace supplier.

19. The process of claim 1 wherein said step of providing a service offering system comprises:
adding functionality provided by the service interface broker to an existing service offering system when there is an existing service offering system that a service developer wants included in the computer network based universal reservation system.

20. The process of claim 19 wherein said step of adding functionality provided by the service interface broker to an existing service offering system is performed by the service developer.

21. The process of claim 1 wherein said step of providing a marketplace system comprises:
adding functionality provided by the marketplace interface broker to an existing marketplace system when there is an existing marketplace system that a marketplace supplier wants included in the computer network based universal reservation system.

22. The process of claim 21 wherein said step of adding functionality provided by the marketplace interface broker to an existing marketplace system is performed by the marketplace supplier.

23. The process of claim 1 wherein the computer network based universal reservation system enables reservations by one or more customers of services offered by one or more service providers, and wherein a service offered by the one or more service providers comprises an arrangement wherein a customer receives the use of a resource from a service provider.

24. The process of claim 23 wherein the customer receives use of the resource for a scheduled period of time.

25. The process of claim 23 wherein the service provider maintains ownership of the resource during the service.

26. The process of claim 23 wherein the resource comprises a good.

27. The process of claim 23 wherein the resource comprises an activity that is performed.

28. The process of claim 27 wherein at least a portion of the activity is performed by one or more individuals.

29. The process of claim 27 wherein at least a portion of the activity is performed by a device.

30. A process of developing a computer network based universal reservation system that enables reservations by one or more customers of services offered by one or more service providers, and wherein a service offered by the one or more service providers comprises an arrangement wherein a customer receives the use of a resource from a service provider, said process comprising the steps of:
providing a scheduling agent system;
providing a service interface broker to a service developer, wherein the service interface broker is usable by the service developer to develop a service offering system including functionality provided by the service interface broker when there is not an existing service offering system that the service developer wants included in the computer network based universal reservation system and to add functionality provided by the service interface broker to an existing service offering system when there is an existing service offering system that a service developer wants included in the computer network based universal reservation system, and wherein functionality of the service offering system is extended by functionality provided by the service interface broker;
providing a marketplace interface broker to a marketplace supplier, wherein the marketplace interface broker is usable by the marketplace supplier to develop a marketplace system including functionality provided by the marketplace interface broker when there is not an existing marketplace system that the marketplace supplier wants included in the computer network based universal reservation system and to add functionality provided by the marketplace interface broker to an existing marketplace system when there is an existing marketplace system that a marketplace supplier wants included in the computer network based universal reservation system, and wherein functionality of the marketplace system is extended by functionality provided by the marketplace interface broker; and
including in the computer network based universal reservation system at least one of the scheduling agent system, the service offering system with the functionality provided by the service interface broker, and the marketplace system with the functionality provided by the marketplace interface broker.

31. The process of claim 30 further comprising the step of:
developing at least one media interface for accessing the service offering system.

32. The process of claim 31 wherein the at least one media interface is developed by the service developer.

33. The process of claim 31 wherein the at least one media interface enables two-way communication between the service offering system and a service provider, wherein the at least one media interface enables operation of the service offering system by the service provider to define offers of services available for reservation.

34. The process of claim 30 further comprising the step of:
developing at least one media interface for accessing the marketplace system.

35. The process of claim 34 wherein the at least one media interface is developed by the marketplace supplier.

36. The process of claim 34 wherein the at least one media interface provides at least one-way communication from the marketplace system to customers, wherein offers of services available for reservation defined by a service provider are communicated from the marketplace system to the customers via the at least one media interface.

37. The process of claim 36 wherein the at least one media interface provides two-way communication between the marketplace system and the customers, wherein reservation requests by the customers are communicated from the customers to the marketplace system via the same at least one media interface.

38. The process of claim 36 wherein at least one additional media interface provides at least return channel communication from the customers to the marketplace systems, and wherein reservation requests by the customers are communicated from the customers to the marketplace system via the at least one additional media interface.

39. The process of claim 30 wherein the customer receives use of the resource for a scheduled period of time.

40. The process of claim 30 wherein the service provider maintains ownership of the resource during the service.

41. The process of claim 30 wherein the resource comprises a good.

42. The process of claim 30 wherein the resource comprises an activity that is performed.

43. The process of claim 42 wherein at least a portion of the activity is performed by one or more individuals.

44. The process of claim 43 wherein at least a portion of the activity is performed by a device.
